(19) United States
(12) Patent Application Publication
(10) Pub. No.: US 2026/0329635 A1
(43) Pub. Date: Oct. 22, 2026

(54) ARTIFICIAL INTELLIGENCE AGENT SYSTEM AND ARTIFICIAL INTELLIGENCE AGENT METHOD

(71) Applicant: COMPAL ELECTRONICS, INC., Taipei City (TW)

(72) Inventors: Hui-Wen Chan, Taipei City (TW); Li-Cheng Chiang, Taipei City (TW); Hong-Tien Wang, Taipei City (TW); Chih-Chien Liu, Taipei City (TW)

(73) Assignee: COMPAL ELECTRONICS, INC., Taipei City (TW)

(21) Appl. No.: 19/578,943

(22) Filed: Mar. 26, 2026

Related U.S. Application Data
(60) Provisional application No. 63/778,404, filed on Mar. 27, 2025.

(51) Int. Cl. G06F 9/48; G06F 11/34

(52) U.S. Cl. CPC G06F 9/4881; G06F 11/3495

(57) ABSTRACT

An artificial intelligence (AI) agent system and an AI agent method are provided. The AI agent system includes an agent repository management module, an agent register module, an agent proxy interface module, and a core scheduling module. The agent register module is coupled to the agent repository management module. The agent repository management module manages the functional descriptions, version information, message channel application interfaces, health status, and access control information of multiple AI agent modules recorded in the agent register module. The agent proxy interface module is coupled to the agent repository management module and the multiple AI agent modules. The core scheduling module is coupled to the agent proxy interface module. The agent proxy interface module receives scheduling requests sent by the core scheduling module and sends the scheduling request to at least one of the multiple AI agent modules based on the functional descriptions, version information, message channel application interfaces, health status, and access control information of the multiple AI agent modules recorded in the agent register module.

### CROSS-REFERENCE TO RELATED APPLICATION

This application claims the priority benefit of U.S. provisional application Ser. No. 63/778,404, filed on Mar. 27, 2025. The entirety of the above-mentioned patent application is hereby incorporated by reference herein and made a part of this specification.

### BACKGROUND

### Technical Field

The present invention relates to an agent system, and particularly relates to an artificial intelligence agent system and an artificial intelligence agent method.

### Description of Related Art

Due to the rapid development of artificial intelligence (AI) and machine learning technologies in recent years, the industry has gradually adopted a plurality of artificial intelligence agent modules with different functions or algorithms to handle various complex tasks. However, in scenarios where multiple proxies operate collaboratively, different proxies typically have different communication protocols, interface formats, resource requirements, and authorization mechanisms, resulting in difficulties in integration and expansion.

### SUMMARY

The artificial intelligence agent system of the present invention includes an agent repository management module, an agent repository management module, an agent proxy interface module, and a core scheduling module. The agent repository management module is coupled to the agent repository management module. The agent repository management module manages functional descriptions, version information, message channel application program interfaces, health status, and permission control information of a plurality of artificial intelligence agent modules recorded in the agent repository management module. The agent proxy interface module is coupled to the agent repository management module and the plurality of artificial intelligence agent modules. The core scheduling module is coupled to the agent proxy interface module. The agent proxy interface module is configured to receive a scheduling request sent by the core scheduling module, and to send the scheduling request to at least one of the plurality of artificial intelligence agent modules according to the functional descriptions, version information, channel application program interfaces, the health status, and the permission control information of the plurality of artificial intelligence agent modules recorded in the agent repository management module.

The artificial intelligence agent method of the present invention includes the following steps: managing, through the agent repository management module, functional descriptions, version information, message channel application program interfaces, health status, and permission control information of a plurality of artificial intelligence agent modules recorded in the agent repository management module; receiving, through the agent proxy interface module, a scheduling request sent by the core scheduling module; and sending, through the agent proxy interface module, the scheduling request to at least one of the plurality of artificial intelligence agent modules according to the functional descriptions, version information, message channel application program interfaces, health status, and permission control information of the plurality of artificial intelligence agent modules recorded in the agent repository management module.

Based on the above, the artificial intelligence agent system and the artificial intelligence agent method of the present invention may provide an artificial intelligence agent hub architecture. The artificial intelligence agent system and the artificial intelligence agent method of the present invention may propose a complete and scalable design for the agent repository and the agent proxy interface to address the deficiencies of the prior art.

### BRIEF DESCRIPTION OF THE DRAWINGS

FIG. 1 is a schematic diagram of an artificial intelligence agent architecture according to an embodiment of the present invention.

FIG. 2 is a schematic diagram of an artificial intelligence agent system and a plurality of artificial intelligence agent modules according to an embodiment of the present invention.

FIG. 3 is a schematic diagram of an artificial intelligence agent method according to an embodiment of the present invention.

FIG. 4 is a schematic diagram of a registration process and a dynamic monitoring process according to an embodiment of the present invention.

FIG. 5 is a schematic diagram of a scheduling process according to an embodiment of the present invention.

### DESCRIPTION OF THE EMBODIMENTS

In order to make the content of the present invention more easily understood, the following embodiments are specifically cited as examples according to which the present invention can indeed be implemented. In addition, wherever possible, elements/components/steps using the same reference numerals in the drawings and embodiments represent the same or similar parts.

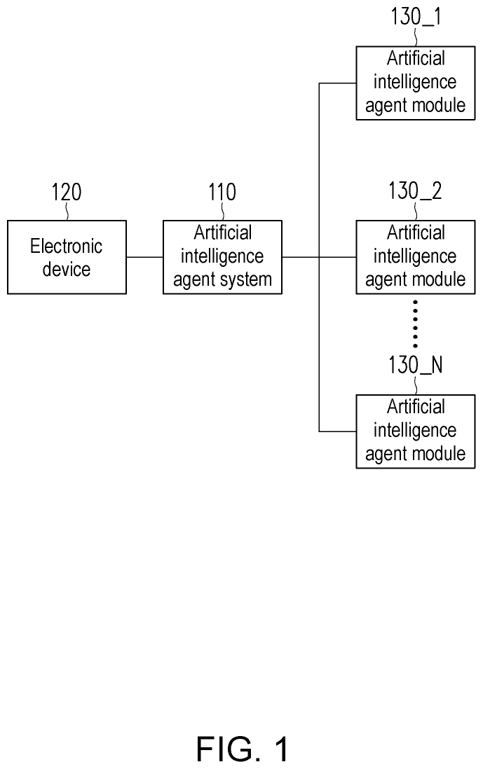

FIG. 1 is a schematic diagram of an artificial intelligence agent architecture according to an embodiment of the present invention. Referring to FIG. 1, the artificial intelligence agent architecture of the present invention includes an artificial intelligence agent system 110, an electronic device 120, and a plurality of artificial intelligence agent modules 130_1~130_N, where N is a positive integer. In the present embodiment, the electronic device 120 may be, for example, a personal computer, a laptop computer, a tablet computer, or a smartphone or other related devices, and may be operated by a user to log in and execute a user interface of the artificial intelligence agent system 110 to perform related artificial intelligence agent operations. The electronic device 120 may be connected to the artificial intelligence agent system 110 via the Internet, for example.

In the present embodiment, the artificial intelligence agent system 110 may be disposed on a cloud server. The artificial intelligence agent modules 130_1~130_N may include, for example, a local LLM-type agent, a local retrieval-augmented generation (RAG) agent, a cloud large language model (LLM-type) agent, or other related model proxies, and may be respectively deployed to one or more on-premises or cloud servers. The artificial intelligence agent system 110 may connect to the artificial intelligence agent modules 130_1~130_N via wired or wireless communication methods. In addition, the aforementioned on-premises and cloud servers may respectively include a processor and a storage device, wherein the storage device may be used to store related models, data, and applications for execution by the processor.

In the present embodiment, the processor may include, for example, a central processing unit (CPU), an image signal processor (ISP), a microcontroller (MCU), or other programmable general-purpose or special-purpose Microprocessors, a digital signal processor (DSP), a programmable controller, an application specific integrated circuits (ASIC), a programmable logic device (PLD), other similar processing devices, or a combination of these devices. In the present embodiment, the storage device may be, for example, a dynamic random access memory (DRAM), a flash memory, or a non-volatile random access memory (NVRAM), or the like. The storage device may be used to store a plurality of modules, related data, and related parameters described below.

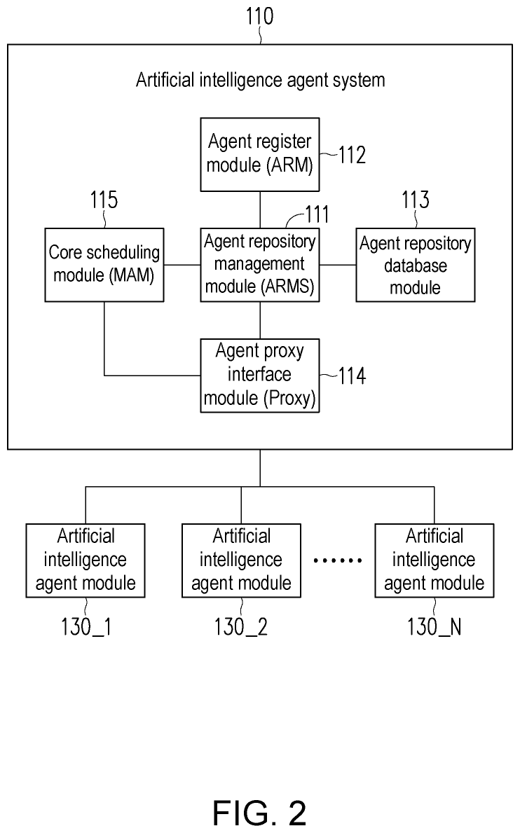

FIG. 2 is a schematic diagram of an artificial intelligence agent system and a plurality of artificial intelligence agent modules according to an embodiment of the present invention. Referring to FIG. 2, the artificial intelligence agent system 110 of the present embodiment includes an agent repository management module 111, an agent register module 112, an agent repository database module 113, an agent proxy interface module 114, and a core scheduling module 115. The agent repository management module 111 is coupled to the agent register module 112, the agent repository database module 113, the agent proxy interface module 114, and the core scheduling module 115.

In the present embodiment, the agent repository management module 111 may implement a multi-attribute and capability annotation function, wherein, for example, annotations for the artificial intelligence agent module include a semantic description field, a message channel application programming interface (API) field, an operational resource requirement field, a version management field, a data type field, and a response service level agreement (SLA) field. The semantic description field is used for natural language descriptions of data, tools, or API functions, enabling the system to understand when to invoke them. The message channel API field is used to record communication interface specifications for communicating with external systems (such as Slack, LINE, or enterprise intranets). The operational resource requirement field is used to record the hardware specifications required to execute the module (for example, required GPU resources, number of CPU cores, and/or memory requirements, etc.). The version management field is used for iterative control of prompts, model weights, or workflows. The data type field is used to record the data formats that the artificial intelligence agent module is capable of reading and outputting (for example, plain text, PDF, image files, JSON, or CAD files). The response service level agreement field is used to record the committed response speed and stability.

In the present embodiment, the agent repository management module 111 may implement dynamic monitoring and health check functions. The agent repository management module 111 may set up a health check mechanism for each registered artificial intelligence agent module 130_1~130_N. The agent repository management module 111 may periodically check whether the artificial intelligence agent modules 130_1~130_N are operating normally, along with their response time and availability. If the agent repository management module 111 detects that a certain artificial intelligence agent module has failed, it may automatically mark it as unavailable and notify the administrator. The agent repository management module 111 may support real-time monitoring and troubleshooting of the artificial intelligence agent modules 130_1~130_N through health indicators and log information.

In the present embodiment, the agent repository management module 111 may implement automated scaling to provide automated deployment and scheduling mechanisms, and may support dynamic scaling of artificial intelligence agent instances based on load. In the present embodiment, the agent repository management module 111 may automatically adjust the number of replicas of a specific artificial intelligence agent module according to demand to satisfy concurrent multi-task request requirements. In the present embodiment, the agent repository management module 111 may implement security and permission management to define access permissions for different artificial intelligence agent modules, so as to ensure that specific sensitive tasks or data may only be invoked through authorized artificial intelligence agent modules or user roles. In the present embodiment, the agent repository management module 111 may be integrated with an organization's identity and access management (IAM) system, for example via AD/Entra ID, to centrally control user permissions for each artificial intelligence agent module.

In the present embodiment, the agent proxy interface module 114 may have a multi-protocol support function, for example, may support different communication methods such as HTTP/REST API, WebSocket, gRPC, Pub/Sub, or Kafka, and may interact with artificial intelligence agent modules across nodes according to different requirements. The agent proxy interface module 114 may also support MCP Client/Server communication. In the present embodiment, the agent proxy interface module 114 may implement data pre-and post-processing and format conversion. The agent proxy interface module 114 may perform necessary cleaning, format conversion, segmentation, or merging of user requests or system messages before invoking the artificial intelligence agent module at the agent layer. After receiving the response from the artificial intelligence agent module, the agent proxy interface module 114 may further perform post-processing or enhancement of the result (for example, summarization, translation, or formatting), and return it to the core scheduling module 115.

In the present embodiment, the agent proxy interface module 114 may perform agent decision and load balancing. In this regard, if there are a plurality of instances of the same type of artificial intelligence agent module, the agent proxy interface module 114 may select the most suitable artificial intelligence agent module for execution based on information such as health check, load, and latency, so as to achieve load balancing. In the present embodiment, the agent proxy interface module 114 may also make agent decisions based on strategies (such as region, latency, etc.) to route requests to the nearest or most efficient artificial intelligence agent module.

In the present embodiment, the agent proxy interface module 114 has a caching mechanism. The agent proxy interface module 114 may cache specific resources or query results that are frequently requested at the agent proxy interface module 114, so as to reduce the count of repeated invocations of the artificial intelligence agent module and improve response speed. The agent proxy interface module 114 may be used in conjunction with a cache invalidation strategy to ensure the timeliness and consistency of data.

In the present embodiment, the agent proxy interface module 114 may perform security verification and data masking. Before communicating with an external artificial intelligence agent module, the agent proxy interface module 114 may first verify whether a user or token has legitimate permission, and may prevent unauthorized invocations. If the transmitted data contains sensitive information, the agent proxy interface module 114 may also perform necessary desensitization or masking to ensure data security.

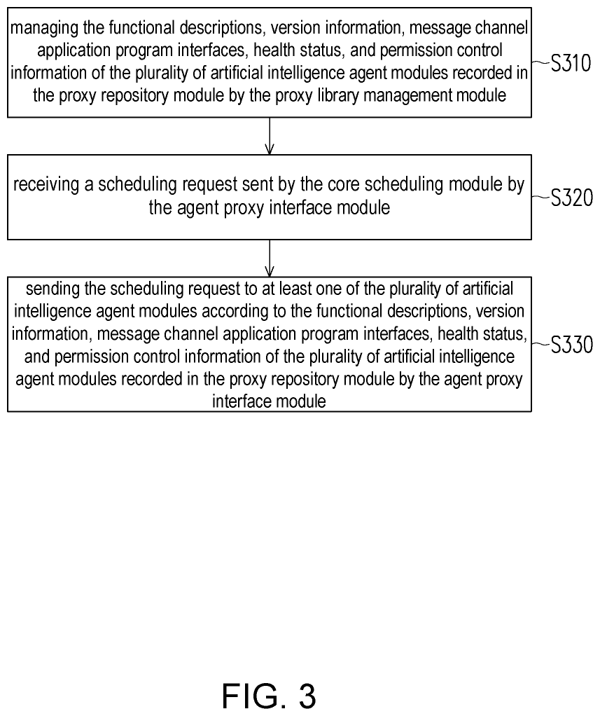

FIG. 3 is a schematic diagram of an artificial intelligence agent method according to an embodiment of the present invention. Referring to FIG. 2 and FIG. 3, the artificial intelligence agent system 110 may execute the following steps S310~S330. In the present embodiment, in a registration phase, the agent register module 112 sends an agent registration request to the agent repository management module 111. The agent repository management module 111 stores corresponding agent information into the agent repository database module 113 according to the agent registration request. In step S310, the agent repository management module 111 manages the functional descriptions, version information, message channel application program interfaces, health status, and permission control information of the plurality of artificial intelligence agent modules 130_1~130_N recorded in the agent repository database module 113. In the present embodiment, the artificial intelligence agent system 110 may execute dynamic monitoring. The agent repository database module 113 is configured to periodically perform health status detection on the artificial intelligence agent modules 130_1~130_N, so as to detect and update the agent status of the artificial intelligence agent modules 130_1~130_N.

In step S320, the agent proxy interface module 114 receives a scheduling request sent by the core scheduling module 115. In step S330, the agent proxy interface module 114 sends the scheduling request to at least one of the plurality of artificial intelligence agent modules 130_1~130_N according to the functional descriptions, version information, message channel application program interfaces, health status, and permission control information of the plurality of artificial intelligence agent modules recorded in the agent repository database module 111. In the present embodiment, in an agent module query phase, when the scheduling request corresponds to a plurality of modules among the plurality of artificial intelligence agent modules 130_1~130_N that match the scheduling request, the agent proxy interface module 114 calculates an evaluation score according to the health status, load information, response time, error rate, service level agreement, and scheduling weight of the plurality of modules, and selects the corresponding artificial intelligence agent module for execution according to the evaluation score. The health status may be converted according to the update time.

In one embodiment, the agent proxy interface module 114 may calculate the evaluation score according to the formula: S=A×25%+B×25%+C×20%+D×10%+E×10%+F×10%, where A is a first parameter of the load information, B is a second parameter of the response time, C is a third parameter of the error rate, D is a fourth parameter of the service level agreement, E is a fifth parameter of the scheduling weight, and F is the health status. In one embodiment, the first parameter, the second parameter, and the third parameter are reverse normalization parameters (score=(max−value)/(max−min)×100) of the load information, the response time, and the error rate, respectively, and the fourth parameter and the fifth parameter are min-max normalization parameters (score=(value−min)/(max−min)×100) of the service level agreement and the scheduling weight, respectively. Furthermore, the agent proxy interface module 114 selects the one among the plurality of modules having the maximum evaluation score for execution.

For example, in an example embodiment, the maximum value of the load information is 70, and the minimum value of the load information is 25. The maximum value of the response time is 18, and the minimum value of the response time is 12. The maximum value of the error rate is 1.5, and the minimum value of the error rate is 0.2. The maximum value of the availability of the service level agreement is 99.9, and the minimum value of the availability of the service level agreement is 99.0. The maximum value of the scheduling weight is 0.9, and the minimum value of the scheduling weight is 0.6.

The load information of the first artificial intelligence agent module is 55, and the response time is 18 (seconds). The error rate of the first artificial intelligence agent module is 0.8. The availability of the service level agreement of the first artificial intelligence agent module is 99.5. The scheduling weight of the first artificial intelligence agent module is 0.7. The health status of the first artificial intelligence agent module is 90. Therefore, by substituting the above values into the corresponding formula, the following parameters may be obtained: the first parameter of the first artificial intelligence agent module is 33.3, where 33.3=(70−55)/(70−25)×100. The second parameter of the first artificial intelligence agent module is 0, where 0=(18−18)/(18−12)×100. The third parameter of the first artificial intelligence agent module is 53.8, where 53.8=(1.5−0.8)/(1.5−0.2)×100). The fourth parameter of the first artificial intelligence agent module is 55.6, where 55.6=(99.5−99.0)/(99.9−99.0)×100). The fifth parameter of the first artificial intelligence agent module is 33.3, where 33.3=(0.7−0.6)/(0.9−0.6)×100. Therefore, the agent proxy interface module 114 may calculate the evaluation score of the first artificial intelligence agent module as 36.98, where 36.98=33.3×25%+0×25%+53.8×20%+55.6×10%+33.3×10%+90×10%.

The load information of the second artificial intelligence agent module is 25, and the response time is 12 (seconds). The error rate of the second artificial intelligence agent module is 0.2. The availability of the service level agreement of the second artificial intelligence agent module is 99.0. The scheduling weight of the second artificial intelligence agent module is 0.6. The health status of the second artificial intelligence agent module is 100. Therefore, by substituting the above values into the corresponding formula, the following parameters may be obtained: the first parameter of the second artificial intelligence agent module is 100, where 100=(70−25)/(70−25)×100. The second parameter of the second artificial intelligence agent module is 100, where 100=(18−12)/(18−12)×100. The third parameter of the second artificial intelligence agent module is 100, where 100=(1.5−0.2)/(1.5−0.2)×100. The fourth parameter of the second artificial intelligence agent module is 100, where 100=(99.9−99.0)/(99.9−99.0)×100. The fifth parameter of the second artificial intelligence agent module is 100, where 100=(0.9−0.6)/(0.9−0.6)×100. Therefore, the agent proxy interface module 114 may calculate the evaluation score of the second artificial intelligence agent module as 100, where 100=100×25%+100×25%+100×20%+100×10%+100×10%+100×10%.

The load information of the third artificial intelligence agent module is 70, and the response time is 14 (seconds). The error rate of the third artificial intelligence agent module is 1.5. The availability of the service level agreement of the third artificial intelligence agent module is 99.0. The scheduling weight of the third artificial intelligence agent module is 0.6. The health status of the third artificial intelligence agent module is 40. Therefore, by substituting the above values into the corresponding formula, the following parameters may be obtained: the first parameter of the third artificial intelligence agent module is 0, where 0=(70−70)/(70−25)×100. The second parameter of the third artificial intelligence agent module is 66.7, where 66.7=(18−14)/(18−12)×100. The third parameter of the third artificial intelligence agent module is 0, where 0=(1.5−1.5)/(1.5−0.2)×100. The fourth parameter of the third artificial intelligence agent module is 0, where 0=(99.0−99.0)/(99.9−99.0)×100. The fifth parameter of the third artificial intelligence agent module is 0, 0=(0.6−0.6)/(0.9−0.6)×100. Therefore, the agent proxy interface module 114 may calculate the evaluation score of the third artificial intelligence agent module as 20.68, where 20.68=0×25%+66.7×25%+0×20%+0×10%+0×10%+40×10%.

Therefore, the agent proxy interface module 114 may select the second artificial intelligence agent module having the maximum evaluation score for execution to satisfy the scheduling request.

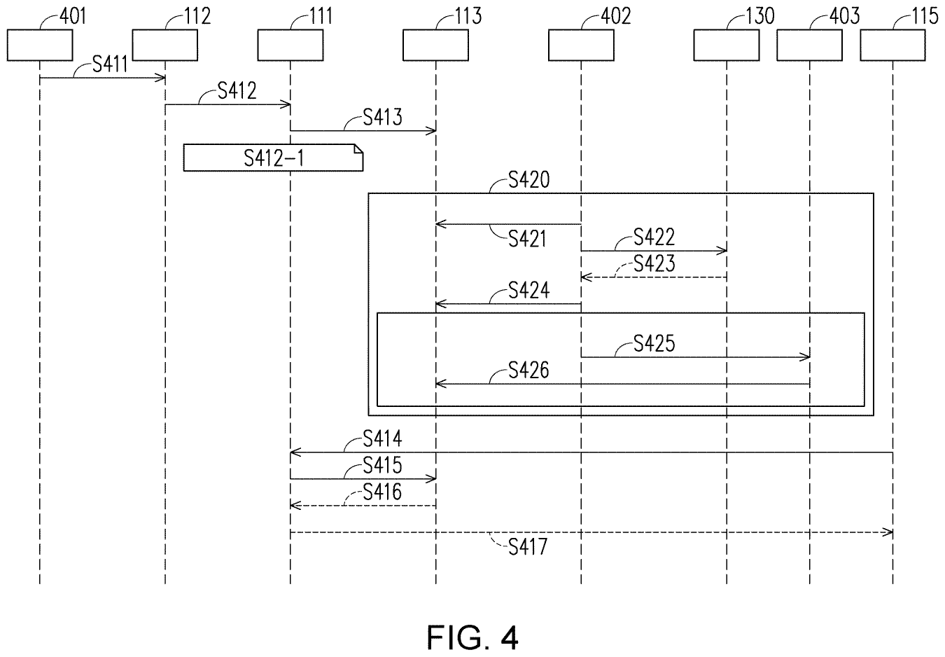

FIG. 4 is a schematic diagram of a registration process and a dynamic monitoring process according to an embodiment of the present invention. Referring to FIG. 1, FIG. 2, and FIG. 4, in the present embodiment, the artificial intelligence agent system 110 may execute the following registration process. The electronic device 120 may operate an application 401 to perform registration of the artificial intelligence agent module. In step S411, the application 401 may output registration data (metadata) of a new artificial intelligence agent module to the agent register module 112. In step S412, the agent register module 112 sends module information and registration information of the new artificial intelligence agent module to the agent repository management module 111 according to the registration data. In step S412-1, the agent repository management module 111 may set initial permissions, version numbers, and perform a preliminary health check. In step S413, the agent repository management module 111 records the functional description, version information, message channel program interface, health status, and permission control information of the new artificial intelligence agent module in the agent repository database module 113.

In the present embodiment, the artificial intelligence agent system 110 may execute the following cyclic execution step S420 of the dynamic monitoring process. In step S421, the health check and monitoring module 402 embedded in the agent repository management module 111 may read a list of all registered artificial intelligence agent modules 130_1~130_N from the agent repository database module 113. In step S422, the health check and monitoring module 402 may connect to the artificial intelligence agent modules 130_1~130_N to periodically probe the operating status of each of the artificial intelligence agent modules 130_1~130_N (e.g., Ping/heartbeat check, API response latency, etc.). In step S423, each of the artificial intelligence agent modules 130_1~130_N may return a status (e.g., probe information such as success, failure, or latency) to the agent repository management module 111. In step S424, the agent repository management module 111 writes the result back to the agent repository database module 113 to update the operating status of each of the artificial intelligence agent modules 130_1~130_N. In one embodiment, when a situation of excessive load or unavailability of the artificial intelligence agent module occurs, in step S425, the health check and monitoring module 402 may notify the adjustment module 403 integrated with the cloud or container platform. In step S426, the adjustment module 403 updates the instance count and/or location of the artificial intelligence agent module.

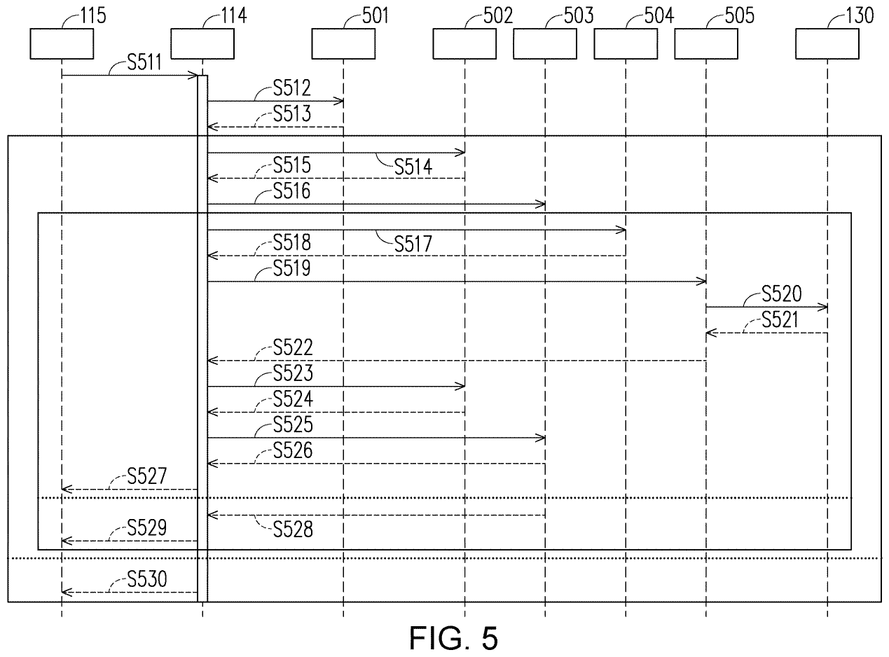

In the present embodiment, the artificial intelligence agent system 110 may execute the following query process. In step S414, when the core scheduling module 115 needs to assign a task to an artificial intelligence agent module according to usage requirements, the core scheduling module 115 may query the agent repository management module 111 for a suitable artificial intelligence agent module (e.g., based on functionality, version, and/or status, etc.). In step S415, the agent repository management module 111 queries the artificial intelligence agent modules that meet the conditions through the agent repository database module 113. In step S416, the agent repository database module 113 returns the query result. In step S417, the agent repository database module 113 returns information such as a list of artificial intelligence agent modules that meet the conditions, status, permissions, and/or service level agreement to the core scheduling module 115. The core scheduling module 115 may further execute a detailed query process as in the embodiment of FIG. 5 below.

FIG. 5 is a schematic diagram of a scheduling process according to an embodiment of the present invention Referring to FIG. 1, FIG. 2, and FIG. 5, in the present embodiment, the artificial intelligence agent system 110 may execute the following scheduling process. In step S511, the core scheduling module 115 further sends a scheduling request (e.g., including user information and task data) to the agent proxy interface module 114 according to the information such as the list of artificial intelligence agent modules that meet the conditions, status, permissions, and/or service level agreement obtained as described above. In this regard, the agent proxy interface module 114 determines whether the scheduling request has permission to decide to send the scheduling request to at least one of the artificial intelligence agent modules 130_1~130_N (i.e., the artificial intelligence agent module 130 described below). Furthermore, at least one of the artificial intelligence agent modules 130_1~130_N may output response data to the agent proxy interface module 114 according to the scheduling request, and the agent proxy interface module 114 performs data verification on the response data.

In step S512, the agent proxy interface module 114 verifies user data or server-side tokens, signatures, and/or credentials, etc., with the security verification and data masking module 501 disposed within the artificial intelligence agent system 110. In step S513, the security verification and data masking module 501 returns the verification result. In step S514, the agent proxy interface module 114 requests the data pre-and post-processing and format conversion module 502 disposed within the artificial intelligence agent system 110 to perform pre-processing, so as to perform operations such as formatting, validation, or word segmentation and sentence splitting on the original requirements or data. In step S515, the data pre-and post-processing and format conversion module 502 returns the processing result. In step S516, the agent proxy interface module 114 checks with the cache module 503 disposed within the artificial intelligence agent system 110 whether any available cache data exists, and if so, directly returns the cache data to improve efficiency.

In one embodiment, when no available cache data exists, in step S517, the agent proxy interface module 114 requests the agent decision and load balancing module 504 disposed within the artificial intelligence agent system 110 for an instance of the optimal artificial intelligence agent module. In step S518, the agent decision and load balancing module 504 returns the instance of the optimal artificial intelligence agent module. In step S519, the agent proxy interface module 114 connects to the multi-protocol support module 505 disposed within the artificial intelligence agent system 110. The multi-protocol support module 505 may dynamically select modes such as HTTP, gRPC, WebSocket, MCP, or Pub/Sub (Kafka) according to requirements. In step S520, the agent proxy interface module 114 sends a request to the corresponding artificial intelligence agent module 130 through the multi-protocol support module 505. In step S521, the artificial intelligence agent module 130 returns response data to the multi-protocol support module 505. In step S522, the multi-protocol support module 505 transmits the raw response data to the agent proxy interface module 114.

In step S523, the agent proxy interface module 114 requests the data pre-and post-processing and format conversion module 502 to perform post-processing, so as to perform data enhancement on the response returned by the artificial intelligence agent module 130, such as summarization processing, multilingual translation processing, typesetting processing, splitting or merging processing, etc. In step S524, the data pre-and post-processing and format conversion module 502 returns the post-processing result to the agent proxy interface module 114. In step S525, the agent proxy interface module 114 connects to the cache module 503 to update the cache data. In step S526, the cache module 503 returns the update result. In step S527, the agent proxy interface module 114 returns the final result to the core scheduling module 115. In one embodiment, the agent proxy interface module 114 may perform cache configuration for at least one of the artificial intelligence agent modules 130_1~130_N according to the call count.

In one embodiment, when available cache data exists, in step S528, the cache module 503 may directly return the cache data. In step S529, the agent proxy interface module 114 returns the cache data (i.e., the same as the final result described above) to the core scheduling module 115. In one embodiment, when the agent proxy interface module 114 performs verification with the security verification and data masking module 501, and a verification failure of user data or server-side tokens, signatures, and/or credentials, etc. occurs, in step S530, the agent proxy interface module 114 returns error information or verification failure information to the core scheduling module 115.

Referring again to FIG. 2, in an example embodiment, a PDF document is used as input data and presentation data (e.g., PPT) is used as output data as an example. The agent proxy interface module 114 may check the file format and size of the PDF document, and perform necessary data masking on the document content. The agent proxy interface module 114 may convert the request into a standard internal format of the system. Next, the core scheduling module 115 may perform qualification screening to determine whether the PDF document is supported as input data and whether the presentation data is supported as output data. Furthermore, the core scheduling module 115 may determine whether processing of the data at this level is permitted. The core scheduling module 115 may also perform dynamic evaluation, comparing the health status of a plurality of candidate artificial intelligence agent modules, and checking the real-time load and expected response time.

Next, the artificial intelligence agent system 110 may select the corresponding artificial intelligence agent module and perform the actual invocation through the agent proxy interface module 114. The corresponding artificial intelligence agent module may parse the content of the PDF document, generate a summary structure, and finally convert it into presentation data and return it to the artificial intelligence agent system 110. In addition, if the corresponding artificial intelligence agent module fails during execution, the artificial intelligence agent system 110 may also automatically switch to a backup artificial intelligence agent module, or enable a degraded mode to output only text summary results.

In summary, the artificial intelligence agent system and the artificial intelligence agent method of the present invention may effectively organize, compare, and schedule a large number of artificial intelligence agent modules, and may enable proxies of different specifications and different protocols to interoperate. The artificial intelligence agent system and the artificial intelligence agent method of the present invention may also reduce the system burden and improve the data processing speed through operations such as caching, pre-and post-processing, and load balancing. The artificial intelligence agent system and the artificial intelligence agent method of the present invention may also perform automatic health checks and real-time monitoring on the artificial intelligence agent modules to ensure stable operation of the proxies. The artificial intelligence agent system and the artificial intelligence agent method of the present invention may also provide consistent security, format, and user experience through data masking and security verification.

Although the present invention has been disclosed above by way of embodiments, the embodiments are not intended to limit the present invention. Any person of ordinary skill in the art may make some modifications and refinements without departing from the spirit and scope of the present invention. Therefore, the protection scope of the present invention shall be defined by the appended patent scope.

What is claimed is:

1. An artificial intelligence agent system, comprising:
an agent repository management module;
an agent repository database module coupled to the agent repository management module, wherein the agent repository management module manages functional descriptions, version information, message channel program interfaces, health status, and permission control information of a plurality of artificial intelligence agent modules recorded in the agent repository database module;
an agent proxy interface module coupled to the agent repository management module and a plurality of artificial intelligence agent modules; and
a core scheduling module coupled to the agent proxy interface module,
wherein the agent proxy interface module is configured to receive a scheduling request sent by the core scheduling module, and to send the scheduling request to at least one of the plurality of artificial intelligence agent modules according to the functional descriptions, the version information, the message channel program interfaces, the health status, and the permission control information of the plurality of artificial intelligence agent modules recorded in the agent repository database module.

2. The artificial intelligence agent system according to claim 1, further comprising:
an agent register module coupled to the agent repository management module, and configured to send an agent registration request to the agent repository management module,
wherein the agent repository management module stores corresponding agent information into the agent repository database module according to the agent registration request.

3. The artificial intelligence agent system according to claim 1, wherein the agent repository database module is configured to periodically perform health status detection on the plurality of artificial intelligence agent modules to detect and update agent status of the plurality of artificial intelligence agent modules.

4. The artificial intelligence agent system according to claim 1, wherein when the scheduling request corresponds to a plurality of modules among the plurality of artificial intelligence agent modules, the agent proxy interface module calculates an evaluation score according to the health status, load information, response time, error rate, service level protocol, and scheduling weight of the plurality of modules, and selects and executes a corresponding artificial intelligence agent module according to the evaluation score.

5. The artificial intelligence agent system according to claim 4, wherein the agent proxy interface module calculates the evaluation score according to a formula: S=A×25%+B×25%+C×20%+D×10%+E×10%+F×10%,
wherein A is a first parameter of the load information, B is a second parameter of the response time, C is a third parameter of the error rate, D is a fourth parameter of the service level protocol, E is a fifth parameter of the scheduling weight, and F is the health status.

6. The artificial intelligence agent system according to claim 5, wherein the first parameter, the second parameter, and the third parameter are reverse normalization parameters of the load information, the response time, and the error rate, respectively, and the fourth parameter and the fifth parameter are min-max normalization parameters of the service level protocol and the scheduling weight, respectively.

7. The artificial intelligence agent system according to claim 6, wherein the agent proxy interface module selects one of the plurality of modules having a maximum evaluation score to execute.

8. The artificial intelligence agent system according to claim 1, wherein the agent proxy interface module is configured to perform cache configuration on at least one of the plurality of artificial intelligence agent modules according to a call count.

9. The artificial intelligence agent system according to claim 1, wherein the agent proxy interface module is configured to determine whether the scheduling request has permission, so as to decide to send the scheduling request to at least one of the plurality of artificial intelligence agent modules.

10. The artificial intelligence agent system according to claim 1, wherein at least one of the plurality of artificial intelligence agent modules outputs response data to the agent proxy interface module according to the scheduling request, and the agent proxy interface module performs data verification on the response data.

11. An artificial intelligence agent method, comprising:
through an agent repository management module, managing functional descriptions, version information, message channel application program interfaces, health statuses, and permission control information of a plurality of artificial intelligence agent modules recorded in an agent repository database module;
through an agent proxy interface module, receiving a scheduling request sent by a core scheduling module; and
through the agent proxy interface module, sending the scheduling request to at least one of the plurality of artificial intelligence agent modules according to the functional descriptions, the version information, the message channel application program interfaces, the health statuses, and the permission control information of the plurality of artificial intelligence agent modules recorded in the agent repository database module.

12. The artificial intelligence agent method according to claim 11, further comprises:
through an agent register module, sending an agent registration request to the agent repository management module; and
through the agent repository management module, storing corresponding agent information into the agent repository database module according to the agent registration request.

13. The artificial intelligence agent method according to claim 11, further comprises:
through the agent repository database module, periodically performing health status detection on the plurality of artificial intelligence agent modules, so as to detect and update agent status of the plurality of artificial intelligence agent modules.

14. The artificial intelligence agent method according to claim 11, wherein the step of sending the scheduling request to at least one of the plurality of artificial intelligence agent modules comprises:
when the scheduling request corresponds to a plurality of modules among the plurality of artificial intelligence agent modules, through the agent proxy interface module, calculating an evaluation score according to the health statuses, load information, response times, error rates, service level protocols, and scheduling weights of the plurality of modules, and selecting to execute a corresponding artificial intelligence agent module according to the evaluation score.

15. The artificial intelligence agent method according to claim 14, wherein the step of calculating the evaluation score comprises:
through the agent proxy interface module, calculating the evaluation score according to a formula: S=A×25%+B×25%+C×20%+D×10%+E×10%+F×10%,
wherein A is a first parameter of the load information, B is a second parameter of the response time, C is a third parameter of the error rate, D is a fourth parameter of the service level protocol, E is a fifth parameter of the scheduling weight, and F is a health status.

16. The artificial intelligence agent method according to claim 15, wherein the first parameter, the second parameter, and the third parameter are reverse normalization (Reverse Normalization) parameters of the load information, the response time, and the error rate, respectively, and the fourth parameter and the fifth parameter are min-max normalization (Min-Max Normalization) parameters of the service level protocol and the scheduling weight, respectively.

17. The artificial intelligence agent method according to claim 16, wherein the step of selecting to execute the corresponding artificial intelligence agent module according to the evaluation score comprises:
through the agent proxy interface module, selecting one of the plurality of modules having a maximum evaluation score to execute.

18. The artificial intelligence agent method according to claim 11, further comprises:
through the agent proxy interface module, performing cache configuration on at least one of the plurality of artificial intelligence agent modules according to a call count.

19. The artificial intelligence agent method according to claim 11, wherein the step of sending the scheduling request to at least one of the plurality of artificial intelligence agent modules comprises:
through the agent proxy interface module, determining whether the scheduling request has permission, so as to decide to send the scheduling request to at least one of the plurality of artificial intelligence agent modules.

20. The artificial intelligence agent method according to claim 11, further comprises:
through at least one of the plurality of artificial intelligence agent modules, outputting response data to the agent proxy interface module according to the scheduling request; and
through the agent proxy interface module, performing data verification on the response data.
